(19) United States
(12) Patent Application Publication
(10) Pub. No.: US 2015/0207399 A1
(43) Pub. Date: Jul. 23, 2015

(54) PWM CONTROLLER CAPABLE OF CONTROLLING OUTPUT CURRENT RIPPLE VIA A RESISTOR, AND LED DRIVER CIRCUIT USING SAME

(71) Applicant: IMMENSE ADVANCE TECHNOLOGY CORP., New Taipei City (TW)

(72) Inventors: Jian-Shen LI, New Taipei City (TW); Yueh-Hua CHIANG, New Taipei City (TW); Wei-Chun HSIAO, New Taipei City (TW)

(73) Assignee: IMMENSE ADVANCE TECHNOLOGY CORP., New Taipei City (TW)

(21) Appl. No.: 14/158,922

(22) Filed: Jan. 20, 2014

(51) Int. Cl. H02M 1/14; H05B 33/08; H02M 3/156

(52) U.S. Cl. CPC H02M 1/14; H02M 3/156; H05B 33/0815

(57) ABSTRACT

A PWM controller capable of controlling output current ripple via a resistor, and an LED driver circuit using the PWM controller, the PWM controller including: a sawtooth signal generation unit for generating a sawtooth signal, of which a slope of a positive ramp is controlled by a control current, and the control current is determined by an external resistor; an amplifier having a positive input end coupled with a reference voltage, a negative input end coupled with a current sense signal, and an output end coupled with an external capacitor for generating a comparison signal; and a comparator having a positive input end coupled with the sawtooth signal, a negative input end coupled with the comparison signal, and an output end for generating an end-of-conduction signal, wherein the end-of-conduction signal will become active whenever the sawtooth signal reaches the comparison signal.

### BACKGROUND OF THE INVENTION

1. Field of the Invention

The present invention relates to a PWM (pulse width modulation) controller and an LED (light emitting diode) driver circuit, especially to a PWM controller capable of controlling output current ripple via a resistor and an LED driver circuit using the PWM controller.

2. Description of the Related Art

Please refer to FIG. 1, which illustrates a circuit diagram of a prior art LED driver circuit. As illustrated in FIG. 1, the prior art LED driver circuit includes a bridge rectifier 10, a first resistor 11, a first capacitor 12, a PWM controller 13, an NMOS (n type metal oxide semiconductor) transistor 14, an inductor 15, a second capacitor 16, an LED module 17, a second resistor 18, a diode 19, and a third capacitor 20.

The bridge rectifier 10 is used to generate a full-wave-rectified voltage V_{IN} according to an AC power V_{AC}.

The first resistor 11 and the first capacitor 12 are used to generate a DC voltage V_{CC} according to the full-wave-rectified voltage V_{IN}.

The PWM controller 13 includes: a first lead for coupling with a DC voltage V_{CC}; a second lead for providing a PWM signal V_{G} to drive the NMOS transistor 14; a third lead for coupling a current sense signal V_{CS}, which is a positive voltage signal; a fourth lead for coupling to a reference ground; and a fifth lead for coupling with the third capacitor 20 to generate a comparison signal V_{COMP}.

The NMOS transistor 14 has a drain-source channel, which is switched on/off by the PWM signal V_{G}.

The inductor 15 is used to store energy when the NMOS transistor 14 is switched on, and to release energy when the NMOS transistor 14 is switched off.

The second capacitor 16 has a large capacitance value for reducing the ripple of a current I_{LED} flowing through the LED module 17.

The second resistor 18 generates the current sense signal V_{CS} according to a current I_{R} flowing therethrough, wherein V_{CS} is a positive voltage signal.

The diode 19 is used to form a discharging path for the inductor 15 when the NMOS transistor 14 is switched off.

The third capacitor 20 is coupled with the fifth lead of the PWM controller 13 for generating the comparison signal V_{COMP}.

When in operation, the PWM controller 13 will have the difference of the current sense signal V_{CS} and a reference voltage (not shown in the figure) filtered by the third capacitor 20 to generate the comparison signal V_{COMP}; and then the PWM controller 13 will perform a voltage comparison operation on the comparison signal V_{COMP} and a fixed sawtooth signal (not shown in the figure) to determine a duty ratio of the PWM signal V_{G}. When reaching a steady state, due to a negative feedback effect, the average voltage of the current sense signal V_{CS} will approach the reference voltage.

Please refer to FIG. 2, which illustrates a circuit diagram of another prior art LED driver circuit. As illustrated in FIG. 2, the prior art LED driver circuit includes a bridge rectifier 30, a first resistor 31, a first capacitor 32, a PWM controller 33, an NMOS transistor 34, a second resistor 35, an inductor 36, a second capacitor 37, an LED module 38, a diode 39, and a third capacitor 40.

The bridge rectifier 30 is used to generate a full-wave-rectified voltage V_{IN} according to an AC power V_{AC}.

The first resistor 31 and the first capacitor 32 are used to generate a DC voltage V_{CC} according to the full-wave-rectified voltage V_{IN}.

The PWM controller 33 includes: a first lead for coupling with a DC voltage V_{CC}; a second lead for providing a PWM signal V_{G} to drive the NMOS transistor 34; a third lead for coupling a current sense signal V_{CS}, which is a positive voltage signal; a fourth lead for coupling to a reference ground; and a fifth lead for coupling with the third capacitor 40 to generate a comparison signal V_{COMP}.

The NMOS transistor 34 has a drain-source channel, which is switched on/off by the PWM signal V_{G}.

The second resistor 35 generates the current sense signal V_{CS} according to a current I_{R} flowing therethrough, wherein V_{CS} is a negative voltage signal.

The inductor 36 is used to store energy when the NMOS transistor 34 is switched on, and to release energy when the NMOS transistor 34 is switched off.

The second capacitor 37 has a large capacitance value for reducing the ripple of a current I_{LED} flowing through the LED module 38.

The diode 39 is used to form a discharging path for the inductor 36 when the NMOS transistor 34 is switched off.

The third capacitor 40 is coupled with the fifth lead of the PWM controller 33 for generating the comparison signal V_{COMP}.

When in operation, the PWM controller 33 will reverse the polarity of the current sense signal V_{CS} to generate a positive voltage signal (not shown in the figure), and have the difference of the positive voltage signal and a reference voltage (not shown in the figure) filtered by the third capacitor 40 to generate the comparison signal V_{COMP}; and then the PWM controller 33 will perform a voltage comparison operation on the comparison signal V_{COMP} and a fixed sawtooth signal (not shown in the figure) to determine a duty ratio of the PWM signal V_{G}. When reaching a steady state, due to a negative feedback effect, the average voltage of the positive voltage signal will approach the reference voltage.

As the voltage absolute value of the current sense signal V_{CS} is equal to the product of the current I_{R} and the resistance value of the second resistor 35, that is, the resistance value of the second resistor 35 is inversely proportional to the current I_{R}, therefore, by changing the resistance value of the second resistor 35, the current I_{R} can be shifted to result in different average values of the current I_{LED}.

Besides, in FIG. 1, the ripple of the current I_{R} is related to the inductance of the inductor 15 in a way that when the inductance gets larger, the ripple of the current I_{R} will become smaller, and the current I_{LED} will have a smaller ripple thereby; and in FIG. 2, the ripple of the current I_{R} is related to the inductance of the inductor 36 in a way that when the inductance gets larger, the ripple of the current I_{R} will become smaller, and the current I_{LED} will have a smaller ripple thereby. However, the larger the inductance is, the higher the cost will be. As a result, in FIG. 1, the LED driver circuit uses the second capacitor 16 having a large capacitance value to absorb the AC component of the current I_{R}, and thereby reduce the ripple of the current I_{LED}; and in FIG. 2, the LED driver circuit uses the second capacitor 37 having a large capacitance value to absorb the AC component of the current I_{R}, and thereby reduce the ripple of the current I_{LED}.

However, the capacitor of a large capacitance value is not a low cost component and has a short lifetime. As a result, the prior art LED driver circuits of FIG. 1 and FIG. 2 both have the disadvantage of reduced operation lifetime.

To solve the foregoing problems, a novel PWM controller and a corresponding LED driver circuit architecture are needed.

### SUMMARY OF THE INVENTION

One objective of the present invention is to disclose a PWM controller, which is capable of controlling the ripple of an output current via an external resistor.

Another objective of the present invention is to disclose a PWM controller having an output-current-ripple control mechanism, which is capable of providing a high power factor.

Another objective of the present invention is to disclose an LED driver circuit, which is capable of controlling the ripple of an output current via an external resistor.

Still another objective of the present invention is to disclose an LED driver circuit having an output-current-ripple control mechanism, which is capable of providing a high power factor.

To attain the foregoing objectives, a PWM controller capable of controlling output current ripple via a resistor is proposed, including:

a sawtooth signal generation unit, used for generating a sawtooth signal according to a control current, a positive voltage signal, and a constant current, wherein the control current is determined by an external resistor, and the sawtooth signal has a positive ramp, of which a slope is proportional or inversely proportional to the control current;

an amplifier having a positive input end coupled with a reference voltage, a negative input end coupled with a current sense signal, and an output end coupled with an external capacitor for providing a comparison signal; and

a comparator having a positive input end coupled with the sawtooth signal, a negative input end coupled with the comparison signal, and an output end providing an end-of-conduction signal, wherein the end-of-conduction signal will become active whenever the sawtooth signal reaches the comparison signal.

In one embodiment, the positive voltage signal is provided by the current sense signal.

In one embodiment, the current sense signal is processed by a polarity reversing circuit to result in the positive voltage signal.

In one embodiment, the sawtooth signal generation unit includes:

a constant current source having an input end coupled with a DC voltage, and an output end providing a first current, wherein the first current is the constant current;

a capacitor having a first end coupled with the output end of the constant current source, and a second end coupled to a reference ground, wherein, the first end provides the sawtooth signal;

a switch having a first channel end coupled with the first end of the capacitor, a second channel end coupled to the reference ground, and a control input end coupled with a switching signal, wherein the switching signal becomes active to connect electrically the first channel end with the second channel end whenever the sawtooth signal rises in voltage to reach the comparison signal;

a current mirror including a first PMOS (p type metal oxide semiconductor) transistor and a second PMOS transistor, wherein the first PMOS transistor provides a second current to the capacitor;

an NMOS transistor having a drain, a gate, and a source, wherein, the drain is coupled with the second PMOS transistor, and the source is coupled with the external resistor; and

an amplifier having a positive input end coupled with an input voltage, a negative input end coupled with the source of the NMOS transistor, and an output end coupled with the gate of the NMOS transistor, wherein, the input voltage is provided by the positive voltage signal.

In one embodiment, the sawtooth signal generation unit includes:

a constant current source having an input end coupled with a DC voltage, and an output end providing a first current, wherein the first current is the constant current;

a capacitor having a first end coupled with the external resistor and the output end of the constant current source, and a second end coupled to a reference ground, wherein, the first end provides the sawtooth signal;

a switch having a first channel end coupled with the first end of the capacitor, a second channel end coupled to the reference ground, and a control input end coupled with a switching signal, wherein the switching signal becomes active to connect electrically the first channel end with the second channel end whenever the sawtooth signal rises in voltage to reach the comparison signal;

a current mirror including a first PMOS transistor and a second PMOS transistor, wherein the first PMOS transistor provides a second current to the capacitor;

an NMOS transistor having a drain, a gate, and a source, wherein, the drain is coupled with the second PMOS transistor;

an amplifier having a positive input end coupled with an input voltage, a negative input end coupled with the source of the NMOS transistor, and an output end coupled with the gate of the NMOS transistor, wherein, the input voltage is provided by the positive voltage signal; and

a resistor having one end coupled with the source of the NMOS transistor, and another end coupled to the reference ground.

To attain the foregoing objectives, an LED driver circuit capable of controlling output current ripple via a resistor is proposed, including:

a bridge rectifier having two AC input ends, a positive output end, and a negative output end, wherein the two AC input ends are coupled with an AC power, and the positive output end and the negative output end are used to provide a full-wave-rectified voltage;

a PWM controller having: a first lead coupled with a DC voltage; a second lead providing a PWM signal; a third lead coupled with a current sense signal; a fourth lead coupled to a reference ground; a fifth lead coupled with an external resistor to generate a control current; and a sixth lead coupled with an external capacitor to generate a comparison signal;

an NMOS transistor having a drain, a gate, and a source, wherein the drain is coupled with the positive output end, the gate is coupled with the second lead, and the source is coupled with the third lead;

a current sense resistor having one end coupled to the reference ground, and another end coupled with the third lead to provide the current sense signal according to a current flowing through the current sense resistor;

an inductor having one end coupled with the current sense resistor;

an LED module having one end coupled with another end of the inductor, and another end coupled with the negative output end; and

a diode having a cathode coupled with the third lead, and an anode coupled with the negative output end;

wherein, the PWM controller is used to: use the external capacitor to filter an error signal to generate the comparison signal, the error signal being a difference of the current sense signal and a reference voltage; and perform a voltage comparison operation on the comparison signal and a sawtooth signal to determine a duty ratio of the PWM signal, wherein the sawtooth signal has a positive ramp, of which a slope is controlled by the control current.

In one embodiment, the slope of the positive ramp of the sawtooth signal is proportional to the control current.

In one embodiment, the slope of the positive ramp of the sawtooth signal is inversely proportional to the control current.

To attain the foregoing objectives, another LED driver circuit capable of controlling output current ripple via a resistor is proposed, including:

a bridge rectifier having two AC input ends, a positive output end, and a negative output end, wherein the two AC input ends are coupled with an AC power, and the positive output end and the negative output end are used to provide a full-wave-rectified voltage;

a PWM controller having: a first lead coupled with a DC voltage; a second lead providing a PWM signal; a third lead coupled with a current sense signal; a fourth lead coupled to a reference ground; a fifth lead coupled with an external resistor to generate a control current; and a sixth lead coupled with an external capacitor to generate a comparison signal;

an NMOS transistor having a drain, a gate, and a source, wherein the drain is coupled with the positive output end, the gate is coupled with the second lead, and the source is coupled to the reference ground;

a current sense resistor having one end coupled to the reference ground, and another end coupled with the third lead to provide the current sense signal according to a current flowing through the current sense resistor;

an inductor having one end coupled with the current sense resistor;

an LED module having one end coupled with another end of the inductor, and another end coupled with the negative output end; and

a diode having a cathode coupled with the reference ground, and an anode coupled with the negative output end;

wherein, the PWM controller is used to: reverse a polarity of the current sense signal to generate a positive voltage signal; use the external capacitor to filter an error signal to generate the comparison signal, the error signal being a difference of the positive voltage signal and a reference voltage; and perform a voltage comparison operation on the comparison signal and a sawtooth signal to determine a duty ratio of the PWM signal, wherein the sawtooth signal has a positive ramp, of which a slope is controlled by the control current.

In one embodiment, the slope of the positive ramp of the sawtooth signal is proportional to the control current.

In one embodiment, the slope of the positive ramp of the sawtooth signal is inversely proportional to the control current.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a circuit diagram of a prior art LED driver circuit.

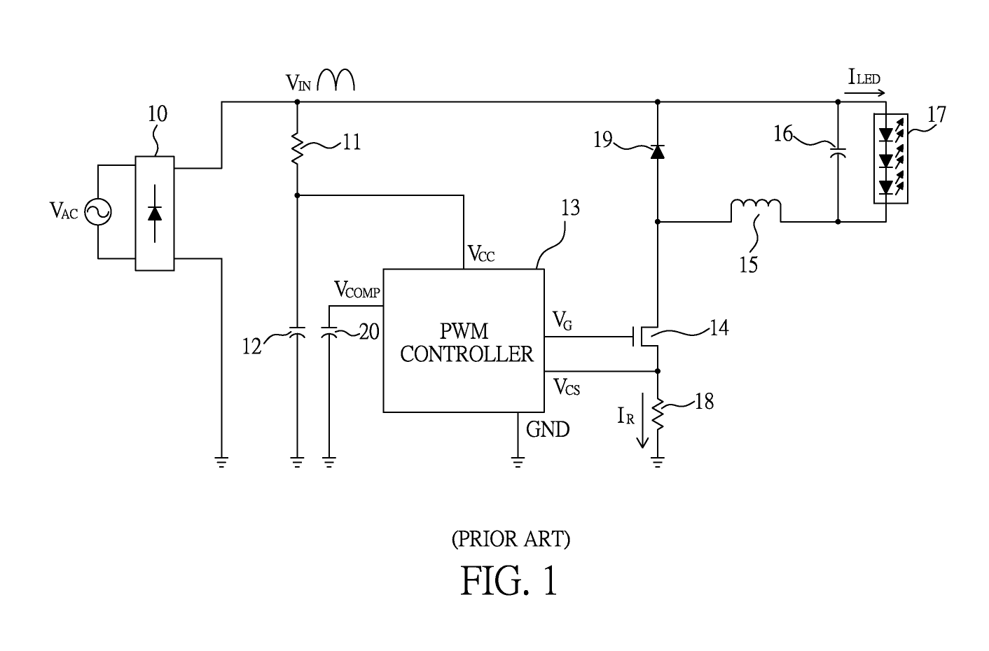

FIG. 2 illustrates a circuit diagram of another prior art LED driver circuit.

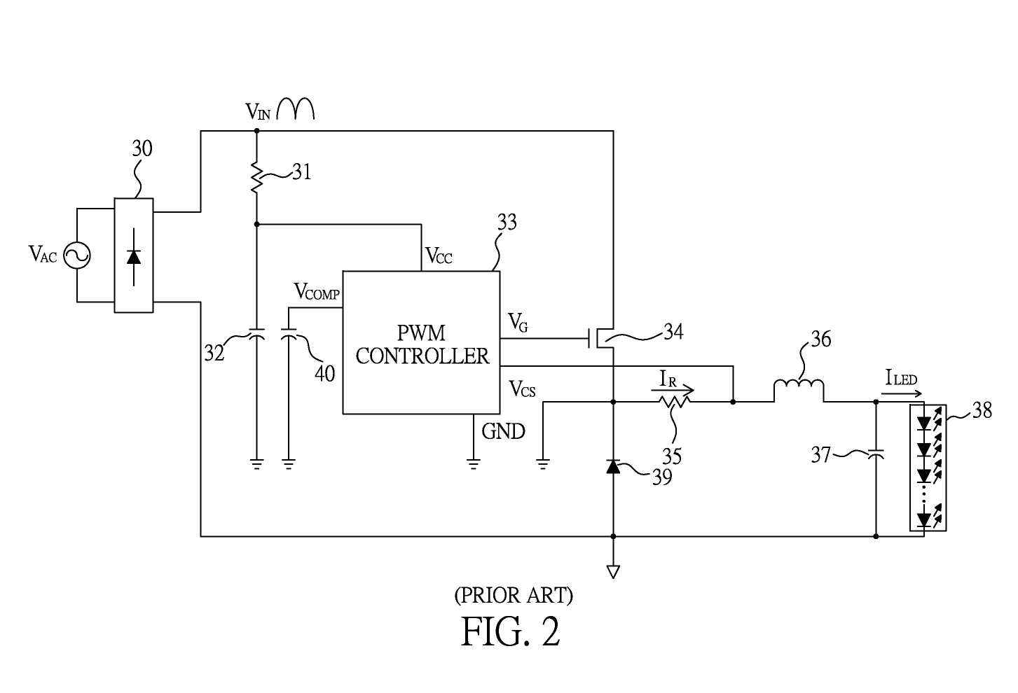

FIG. 3 illustrates a circuit diagram of a preferred embodiment of an LED driver circuit using a PWM controller of the present invention.

FIG. 4 illustrates a circuit diagram of another preferred embodiment of an LED driver circuit using a PWM controller of the present invention.

FIG. 5 illustrates a circuit diagram of a preferred embodiment of a PWM controller of FIG. 3.

FIG. 6 illustrates a circuit diagram of a preferred embodiment of a PWM controller of FIG. 4.

FIG. 7 illustrates a circuit diagram of a preferred embodiment of a sawtooth signal generation unit of FIG. 5 and FIG. 6.

FIG. 8 illustrates a circuit diagram of another preferred embodiment of a sawtooth signal generation unit of FIG. 5 and FIG. 6.

FIG. 9 illustrates a waveform diagram including a sawtooth signal V_{SAW} and a comparison signal V_{COMP} of an embodiment of the present invention when an external resistor is set at a high resistance value.

FIG. 10 illustrates a waveform diagram including a sawtooth signal V_{SAW} and a comparison signal V_{COMP} of an embodiment of the present invention when an external resistor is set at a low resistance value.

FIG. 11 illustrates a waveform of an output current I_{LED1} of an embodiment of the present invention having an external resistor set at a high resistance value, and a waveform of an output current I_{LED2} of another embodiment of the present invention having an external resistor set at a low resistance value.

### DETAILED DESCRIPTION OF THE PREFERRED EMBODIMENTS

The present invention will be described in more detail hereinafter with reference to the accompanying drawings that show the preferred embodiments of the invention.

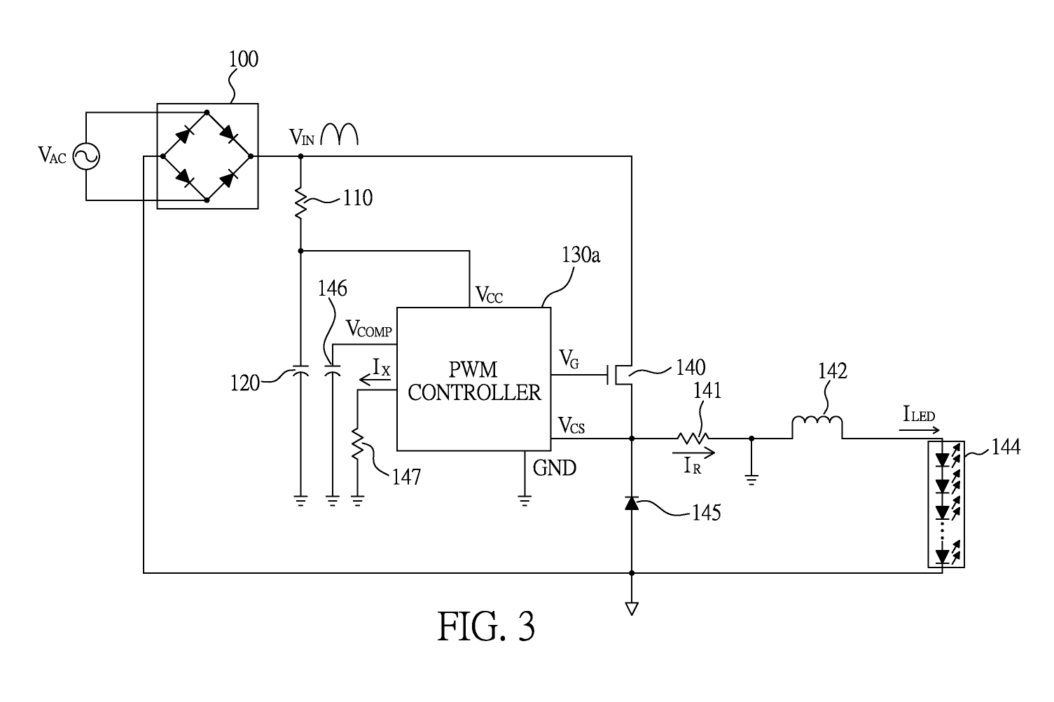

Please refer to FIG. 3, which illustrates a circuit diagram of a preferred embodiment of an LED driver circuit using a PWM controller of the present invention. As illustrated in FIG. 3, the LED driver circuit includes a bridge rectifier 100, a first resistor 110, a first capacitor 120, a PWM controller 130a, an NMOS transistor 140, a second resistor 141, an inductor 142, an LED module 144, a diode 145, a second capacitor 146, and a third resistor 147.

The bridge rectifier 100 has two AC input ends, a positive output end, and a negative output end, wherein the two AC input ends are coupled with an AC power V_{AC}, and the positive output end and the negative output end are used to provide a full-wave-rectified voltage V_{IN}, wherein the negative output end is a first reference ground.

The first resistor 110 and the first capacitor 120 are used to generate a DC voltage V_{CC} according to the full-wave-rectified voltage V_{IN}, wherein the voltage of V_{CC} is relative to a second reference ground.

The PWM controller 130a has: a first lead coupled with a DC voltage V_{CC}; a second lead providing a PWM signal V_{G} to drive the NMOS transistor 140; a third lead coupled with a current sense signal V_{CS}, which is a positive voltage signal; a fourth lead coupled to the second reference ground; a fifth lead coupled with the third resistor 147 to generate a control current I_{X}; and a sixth lead coupled with the second capacitor 146 to generate a comparison signal V_{COMP}.

The NMOS transistor 140 has a drain, a gate, and a source, wherein the drain is coupled with the positive output end, the gate is coupled with the second lead, and the source is coupled with the third lead.

The second resistor 141 is a current sense resistor having one end coupled to the second reference ground, and another end coupled with the third lead to provide the current sense signal V_{CS} according to a current I_{R} flowing through the current sense resistor, wherein, the current sense signal V_{CS} is a positive voltage signal relative to the second reference ground.

The inductor 142 has one end coupled with the second resistor 141. The inductor 142 is used to store energy when the NMOS transistor 140 is switched on, and release energy when the NMOS transistor 140 is switched off.

The LED module 144 has one end coupled with another end of the inductor 142, and another end coupled with the negative output end.

The diode 145, having a cathode coupled with the third lead and an anode coupled with the negative output end, is used to form a discharging path for the inductor 142 when the NMOS transistor 140 is switched off.

The second capacitor 146 is coupled between the second reference ground and the sixth lead of the PWM controller 130a to generate the comparison signal V_{COMP}.

The third resistor 147 is coupled between the second reference ground and the fifth lead of the PWM controller 130a to generate the control current I_{X}.

When in operation, the PWM controller 130a will use the second capacitor 146 to filter an error signal to generate the comparison signal V_{COMP}, the error signal being a difference of the current sense signal V_{CS} and a reference voltage (not shown in the figure); and perform a voltage comparison operation on the comparison signal V_{COMP} and a sawtooth signal (not shown in the figure) to determine a duty ratio of the PWM signal V_{G}. When in a steady state, due to a negative feedback effect, the average voltage of the current sense signal V_{CS} will approach the reference voltage. Besides, the sawtooth signal has a positive ramp, of which a slope is controlled by the control current I_{X}—the slope can be proportional or inversely proportional to the control current I_{X}.

When the slope gets larger/smaller, the voltage level of the comparison signal V_{COMP} will get higher/lower, and the ripple of the current sense signal V_{CS} (that is, the current I_{R}) will become smaller/larger. That is, by changing the resistance value of the third resistor 147, the ripple of the current I_{R} can be altered, and the ripple of the current I_{LED} can be changed thereby.

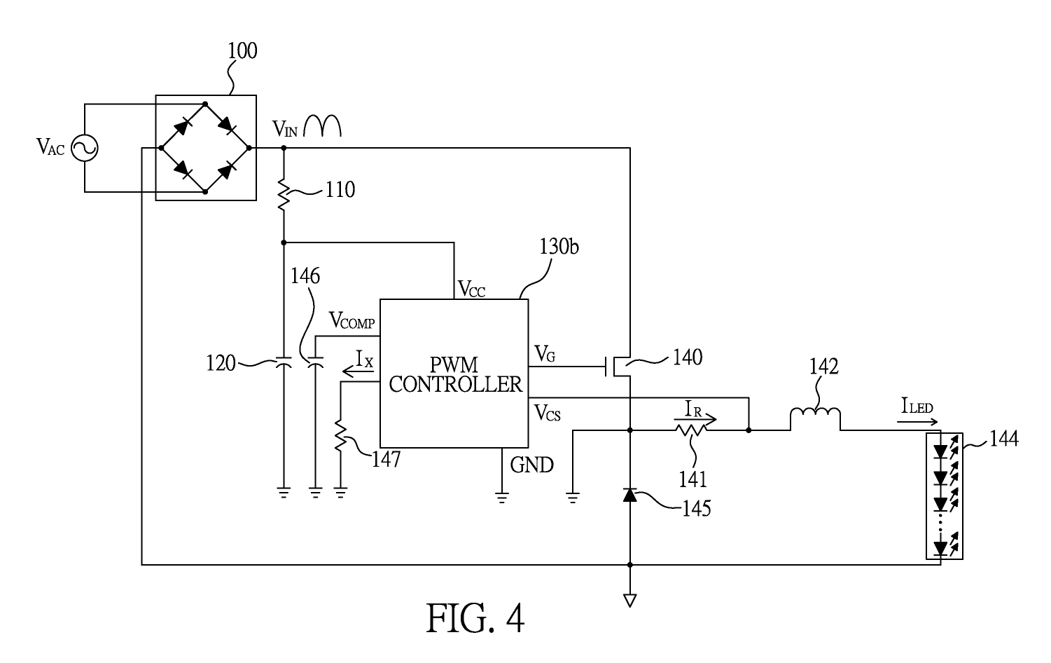

Please refer to FIG. 4, which illustrates a circuit diagram of another preferred embodiment of an LED driver circuit using a PWM controller of the present invention. As illustrated in FIG. 4, the LED driver circuit includes a bridge rectifier 100, a first resistor 110, a first capacitor 120, a PWM controller 130b, an NMOS transistor 140, a second resistor 141, an inductor 142, an LED module 144, a diode 145, a second capacitor 146, and a third resistor 147.

The bridge rectifier 100 has two AC input ends, a positive output end, and a negative output end, wherein the two AC input ends are coupled with an AC power V_{AC}, and the positive output end and the negative output end are used to provide a full-wave-rectified voltage V_{IN}, wherein the negative output end is a first reference ground.

The first resistor 110 and the first capacitor 120 are used to generate a DC voltage V_{CC} according to the full-wave-rectified voltage V_{IN}, wherein the voltage of V_{CC} is relative to a second reference ground.

The PWM controller 130b has: a first lead coupled with a DC voltage V_{CC}; a second lead providing a PWM signal V_{G} to drive the NMOS transistor 140; a third lead coupled with a current sense signal V_{CS}, which is a negative voltage signal; a fourth lead coupled to the second reference ground; a fifth lead coupled with the third resistor 147 to generate a control current I_{X}; and a sixth lead coupled with the second capacitor 146 to generate a comparison signal V_{COMP}.

The NMOS transistor 140 has a drain, a gate, and a source, wherein the drain is coupled with the positive output end, the gate is coupled with the second lead, and the source is coupled with the second reference ground.

The second resistor 141 is a current sense resistor having one end coupled to the second reference ground, and another end coupled with the third lead to provide the current sense signal V_{CS} according to a current I_{R} flowing through the current sense resistor, wherein, the current sense signal V_{CS} is a negative voltage signal relative to the second reference ground.

The inductor 142 has one end coupled with the second resistor 141. The inductor 142 is used to store energy when the NMOS transistor 140 is switched on, and release energy when the NMOS transistor 140 is switched off.

The LED module 144 has one end coupled with another end of the inductor 142, and another end coupled with the negative output end.

The diode 145, having a cathode coupled with the second reference ground and an anode coupled with the negative output end, is used to form a discharging path for the inductor 142 when the NMOS transistor 140 is switched off.

The second capacitor 146 is coupled between the second reference ground and the sixth lead of the PWM controller 130b to generate the comparison signal V_{COMP}.

The third resistor 147 is coupled between the second reference ground and the fifth lead of the PWM controller 130b to generate the control current I_{X}.

When in operation, the PWM controller 130b will reverse a polarity of the current sense signal V_{CS} to generate a positive voltage signal (not shown in the figure); use the second capacitor 146 to filter an error signal to generate the comparison signal V_{COMP}, the error signal being a difference of the positive voltage signal and a reference voltage (not shown in the figure); and perform a voltage comparison operation on the comparison signal V_{COMP} and a sawtooth signal (not shown in the figure) to determine a duty ratio of the PWM signal V_{G}. When in a steady state, due to a negative feedback effect, the average voltage of the positive voltage signal will approach the reference voltage. Besides, the sawtooth signal has a positive ramp, of which a slope is controlled by the control current I_{X}—the slope can be proportional or inversely proportional to the control current I_{X}. When the slope gets larger/smaller, the voltage level of the comparison signal V_{COMP} will get higher/lower, and the ripple of the current sense signal V_{CS} (that is, the current I_{R}) will become smaller/larger. That is, by changing the resistance value of the third resistor 147, the ripple of the current I_{R} can be altered, and the ripple of the current I_{LED} can be changed thereby.

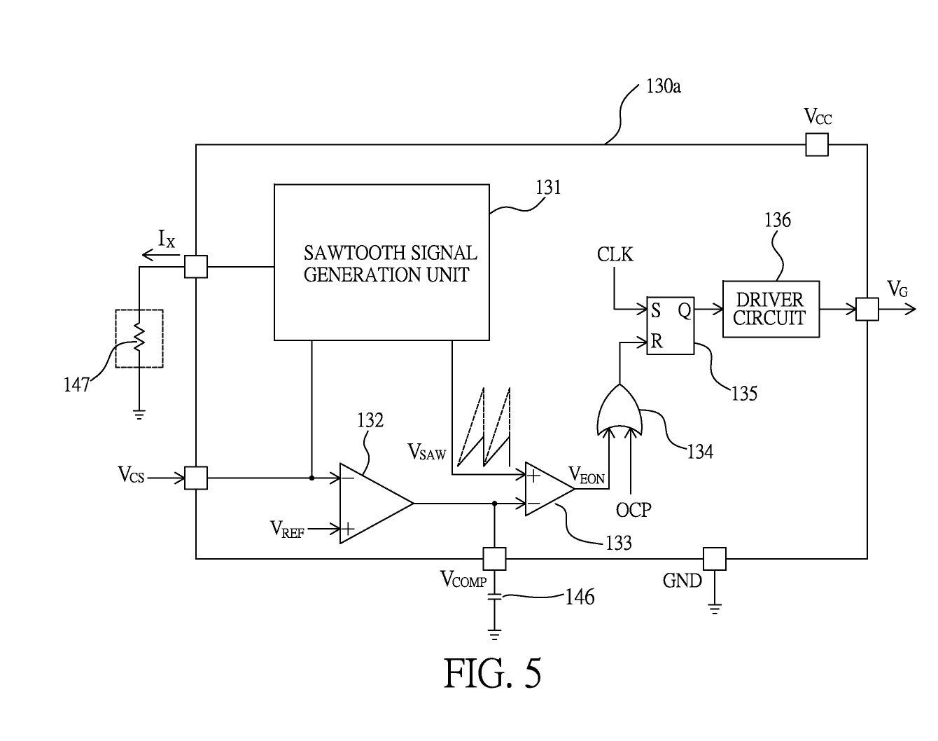

Please refer to FIG. 5, which illustrates a circuit diagram of a preferred embodiment of the PWM controller 130a of FIG. 3. As illustrated in FIG. 5, the PWM controller 130a includes a sawtooth signal generation unit 131, an amplifier 132, a comparator 133, an OR gate 134, a latch 135, and a driver circuit 136.

The sawtooth signal generation unit 131 is used for generating a sawtooth signal V_{SAW} according to the control current I_{X}, the positive voltage signal (provided by the current sense signal V_{CS}), and a constant current (not shown in the figure), wherein the control current I_{X}=V_{CS}/(the resistance value of the third resistor 147), and the sawtooth signal V_{SAW} has a positive ramp, of which a slope is proportional or inversely proportional to the control current I_{X}.

The amplifier 132 has a positive input end coupled with a reference voltage V₁F, a negative input end coupled with the current sense signal V_{CS}, and an output end coupled with the second capacitor 146 for providing the comparison signal V_{COMP}.

The comparator 133 has a positive input end coupled with the sawtooth signal V_{SAW}, a negative input end coupled with the comparison signal V_{COMP}, and an output end delivering an end-of-conduction signal V_{EON} to the OR gate 134, wherein the end-of-conduction signal V_{EON} will become active (for example but not limited to issuing a high level) whenever the sawtooth signal V_{SAW} reaches the comparison signal V_{COMP}.

The OR gate 134 has a first input end coupled with the output end of the comparator 133, a second input end coupled with an over-current-protection signal OCP, and an output end coupled to the latch 135.

The latch 135 has a set input end coupled with a clock signal CLK, a reset input end coupled with the output end of the OR gate 134, and a status output end coupled to the driver circuit 136.

The driver circuit 136 has an input end coupled with the status output end of the latch 135, and an output end providing the PWM signal V_{G}.

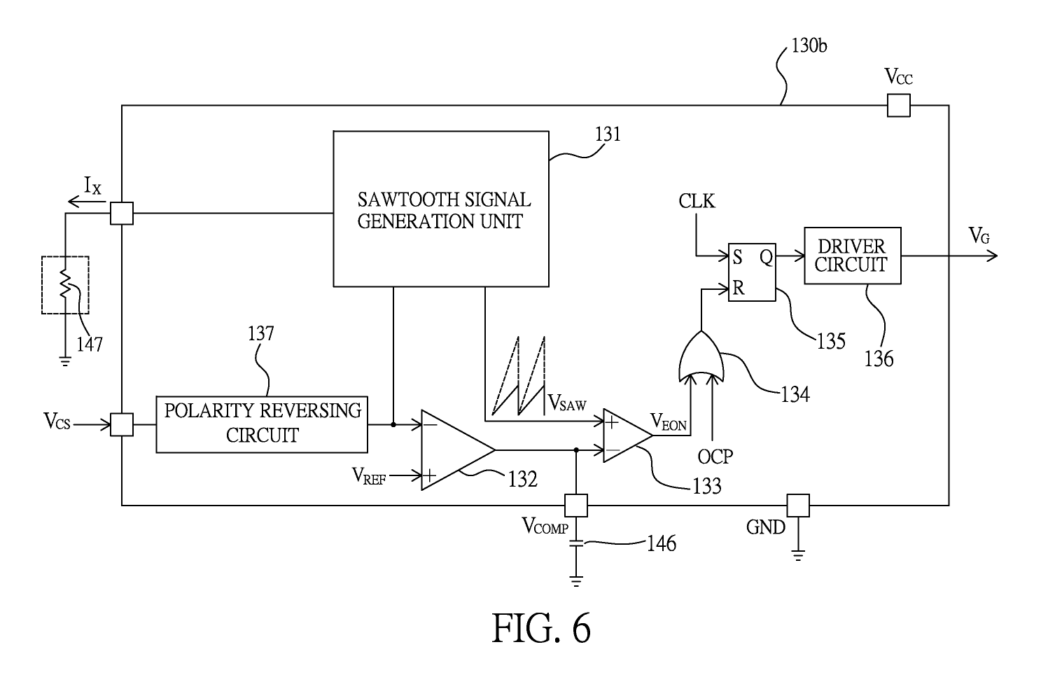

Please refer to FIG. 6, which illustrates a circuit diagram of a preferred embodiment of the PWM controller 130b of FIG. 4. As illustrated in FIG. 6, the PWM controller 130b includes a sawtooth signal generation unit 131, an amplifier 132, a comparator 133, an OR gate 134, a latch 135, a driver circuit 136, and a polarity reversing circuit 137.

The sawtooth signal generation unit 131 is used for generating a sawtooth signal V_{SAW} according to the control current I_{X}, the positive voltage signal (provided by the current sense signal V_{CS}), and a constant current (not shown in the figure), wherein the control current I_{X}=V_{CS}/(the resistance value of the third resistor 147), and the sawtooth signal V_{SAW} has a positive ramp, of which a slope is proportional or inversely proportional to the control current I_{X}.

The amplifier 132 has a positive input end coupled with a reference voltage V₁F, a negative input end coupled with a positive voltage signal delivered by the polarity reversing circuit 137, and an output end coupled with the second capacitor 146 for providing the comparison signal V_{COMP}.

The comparator 133 has a positive input end coupled with the sawtooth signal V_{SAW}, a negative input end coupled with the comparison signal V_{COMP}, and an output end delivering an end-of-conduction signal V_{EON} to the OR gate 134, wherein the end-of-conduction signal V_{EON} will become active (for example but not limited to issuing a high level) whenever the sawtooth signal V_{SAW} reaches the comparison signal V_{COMP}.

The OR gate 134 has a first input end coupled with the output end of the comparator 133, a second input end coupled with an over-current-protection signal OCP, and an output end coupled to the latch 135.

The latch 135 has a set input end coupled with a clock signal CLK, a reset input end coupled with the output end of the OR gate 134, and a status output end coupled to the driver circuit 136.

The driver circuit 136 has an input end coupled with the status output end of the latch 135, and an output end providing the PWM signal V_{G}.

The polarity reversing circuit 137 has an input end coupled with the current sense signal V_{CS}, and an output end providing the positive voltage signal, wherein the voltage of the positive voltage signal is proportional to the voltage absolute value of the current sense signal V_{CS}.

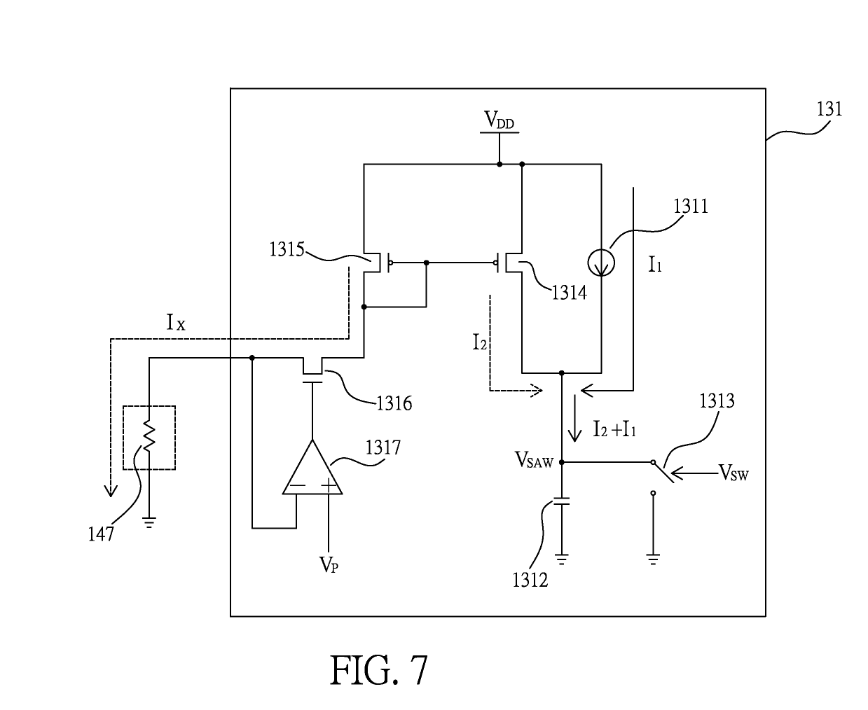

Please refer to FIG. 7, which illustrates a circuit diagram of a preferred embodiment of the sawtooth signal generation unit 131 of FIG. 5 and FIG. 6. As illustrated in FIG. 7, the sawtooth signal generation unit 131 has a constant current source 1311, a capacitor 1312, a switch 1313, a first PMOS transistor 1314, a second PMOS transistor 1315, an NMOS transistor 1316, and an amplifier 1317.

The constant current source 1311 has an input end coupled with a DC voltage V_{DD}, and an output end providing a first current I₁, wherein, the first current I₁ is a constant current.

The capacitor 1312 has a first end coupled with the output end of the constant current source 1311, and a second end coupled to the second reference ground, wherein, the first end is used to provide the sawtooth signal V_{SAW}.

The switch 1313 has a first channel end coupled with the first end of the capacitor 1312, a second channel end coupled to the second reference ground, and a control input end coupled with a switching signal V_{SW}, wherein the switching signal V_{SW} will become active (for example but not limited to issuing a high level) to connect electrically the first channel end with the second channel end to reset the voltage of the capacitor 1312 to zero whenever the sawtooth signal V_{SAW} rises in voltage to reach the comparison signal V_{COMP}.

The first PMOS transistor 1314 and the second PMOS transistor 1315 are used to form a current mirror, which is powered by the DC voltage V_{DD} and provides a second current I₂ to the capacitor 1312 via the first PMOS transistor 1314.

The NMOS transistor 1316 has a drain, a gate, and a source, wherein, the drain is coupled with the second PMOS transistor 1315, and the source is coupled with the third resistor 147.

The amplifier 1317 has a positive input end coupled with an input voltage V_{P}, a negative input end coupled with the source of the NMOS transistor 1316, and an output end coupled with the gate of the NMOS transistor 1316, wherein, the input voltage V_{P} is provided by the positive voltage signal.

When the resistance value of the third resistor 147 gets smaller/larger, the current I_{X} will increase/decrease to cause the second current I₂ to increase/decrease, and the slope of the sawtooth signal V_{SAW} will become larger/smaller thereby. In addition, as the current sense signal V_{CS} also plays a role in determining the sawtooth signal V_{SAW}, therefore, the present invention can also provide a high power factor while control the ripple of an output current.

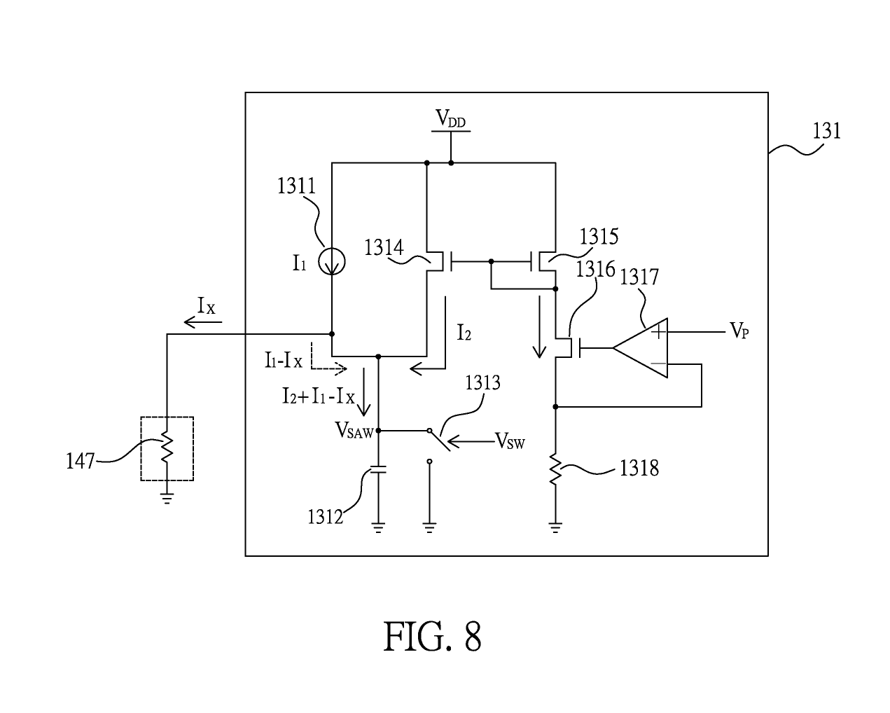

Please refer to FIG. 8, which illustrates a circuit diagram of another preferred embodiment of the sawtooth signal generation unit 131 of FIG. 5 and FIG. 6. As illustrated in FIG. 8, the sawtooth signal generation unit 131 has a constant current source 1311, a capacitor 1312, a switch 1313, a first PMOS transistor 1314, a second PMOS transistor 1315, an NMOS transistor 1316, an amplifier 1317, and a resistor 1318.

The constant current source 1311 has an input end coupled with a DC voltage V_{DD}, and an output end providing a first current I₁, wherein, the first current I₁ is a constant current.

The capacitor 1312 has a first end coupled with the output end of the constant current source 1311 and with the third resistor 147, and a second end coupled to the second reference ground, wherein, the first end is used to provide the sawtooth signal V_{SAW}.

The switch 1313 has a first channel end coupled with the first end of the capacitor 1312, a second channel end coupled to the second reference ground, and a control input end coupled with a switching signal V_{SW}, wherein the switching signal V_{SW} will become active (for example but not limited to issuing a high level) to connect electrically the first channel end with the second channel end to reset the voltage of the capacitor 1312 to zero whenever the sawtooth signal V_{SAW} rises in voltage to reach the comparison signal V_{COMP}.

The first PMOS transistor 1314 and the second PMOS transistor 1315 are used to form a current mirror, which is powered by the DC voltage V_{DD} and provides a second current I₂ to the capacitor 1312 via the first PMOS transistor 1314.

The NMOS transistor 1316 has a drain, a gate, and a source, wherein, the drain is coupled with the second PMOS transistor 1315, and the source is coupled with the resistor 1318.

The amplifier 1317 has a positive input end coupled with an input voltage V_{P}, a negative input end coupled with the source of the NMOS transistor 1316, and an output end coupled with the gate of the NMOS transistor 1316, wherein, the input voltage V_{P} is provided by the positive voltage signal.

The resistor 1318 has one end coupled with the source of the NMOS transistor 1316, and another end coupled to the second reference ground.

When the resistance value of the third resistor 147 gets smaller/larger, the current I_{X} will increase/decrease to cause I₁+I₂−I_{X} to decrease/increase, and the slope of the sawtooth signal V_{SAW} will become smaller/larger thereby. In addition, as the current sense signal V_{CS} also plays a role in determining the sawtooth signal V_{SAW}, therefore, the present invention can also provide a high power factor while control the ripple of an output current.

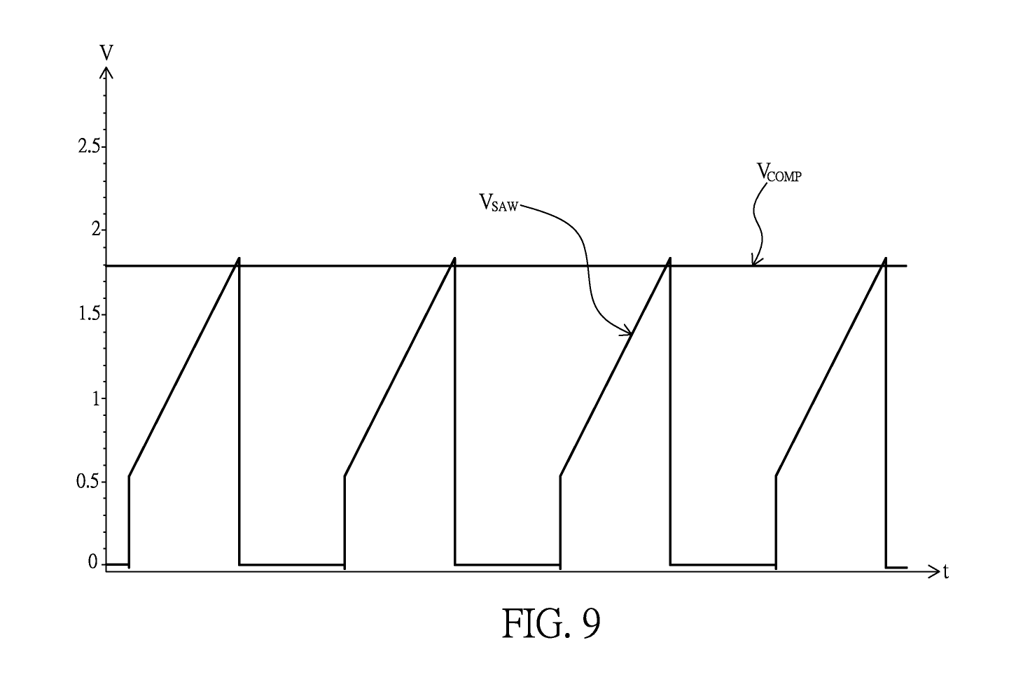

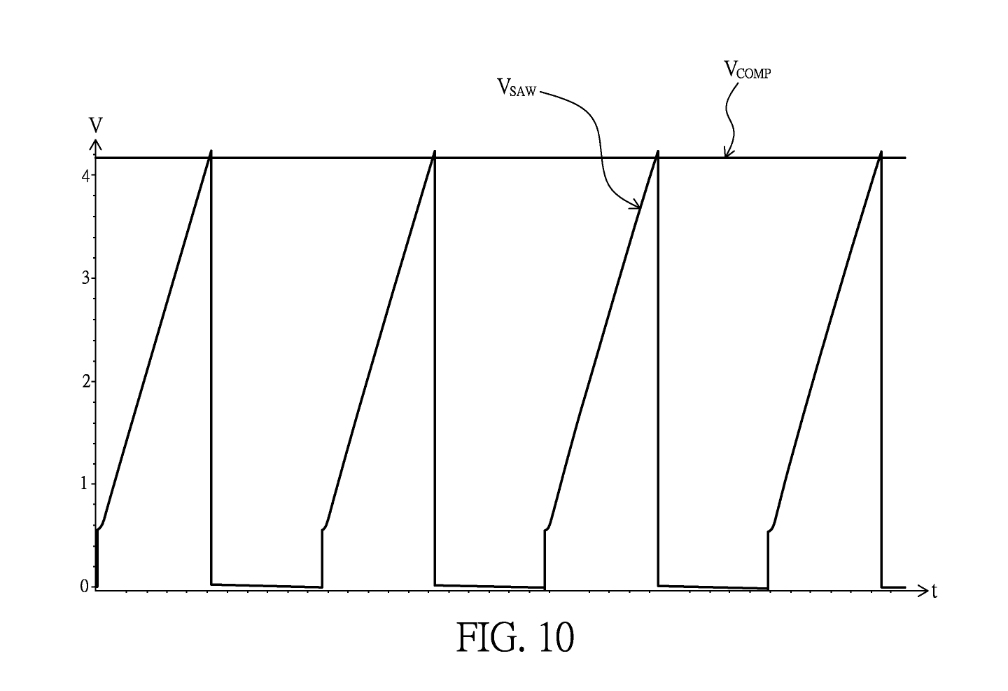

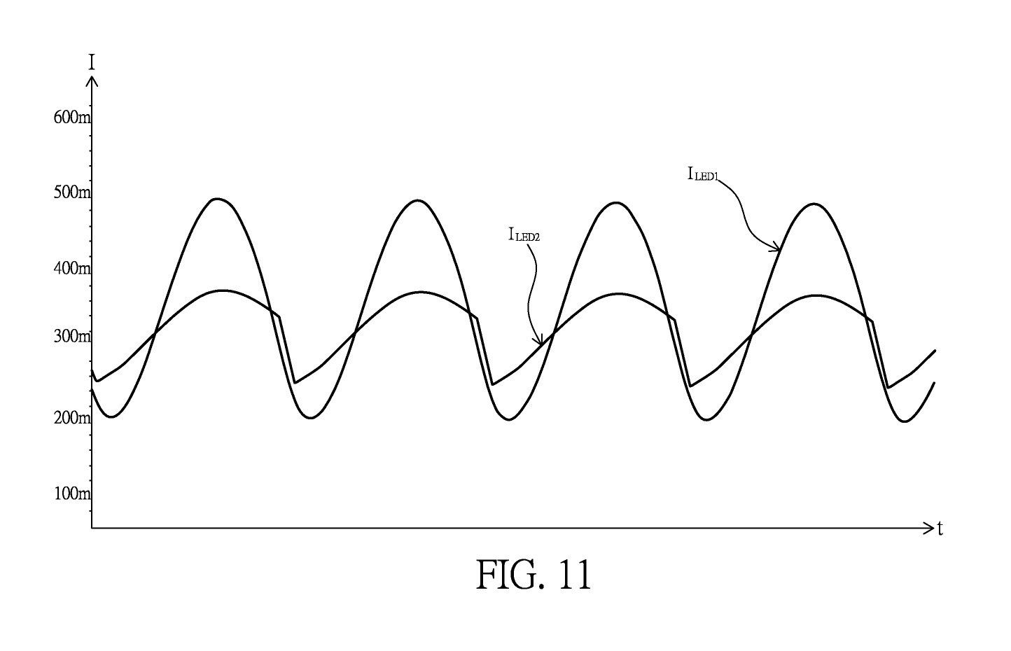

Please refer to FIG. 9-11. When the slope of the sawtooth signal V_{SAW} gets smaller, the level of the comparison signal V_{COMP} will become lower as illustrated in FIG. 9, and the current I_{LED} will have a waveform I_{LED1} of a larger ripple as illustrated in FIG. 11; and when the slope of the sawtooth signal V_{SAW} gets larger, the level of the comparison signal V_{COMP} will become higher as illustrated in FIG. 10, and the current I_{LED} will have a waveform I_{LED2} of a smaller ripple as illustrated in FIG. 11.

Due to the designs mentioned above, the present invention possesses the following advantages:

1. The PWM controller of the present invention is capable of controlling the ripple of an output current via an external resistor.

2. The PWM controller of the present invention has an output-current-ripple control mechanism capable of providing a high power factor.

3. The LED driver circuit of the present invention is capable of controlling the ripple of an output current via an external resistor.

4. The LED driver circuit of the present invention has an output-current-ripple control mechanism capable of providing a high power factor.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A PWM controller capable of controlling output current ripple via a resistor, comprising:
a sawtooth signal generation unit, used for generating a sawtooth signal according to a control current, a positive voltage signal, and a constant current, wherein said control current is determined by an external resistor, and said sawtooth signal has a positive ramp, of which a slope is proportional or inversely proportional to said control current;
an amplifier having a positive input end coupled with a reference voltage, a negative input end coupled with a current sense signal, and an output end coupled with an external capacitor for providing a comparison signal; and
a comparator having a positive input end coupled with said sawtooth signal, a negative input end coupled with said comparison signal, and an output end providing an end-of-conduction signal, wherein said end-of-conduction signal will become active whenever said sawtooth signal reaches said comparison signal.

2. The PWM controller capable of controlling output current ripple via a resistor as claim 1, wherein said positive voltage signal is provided by said current sense signal.

3. The PWM controller capable of controlling output current ripple via a resistor as claim 1, wherein said current sense signal is processed by a polarity reversing circuit to result in said positive voltage signal.

4. The PWM controller capable of controlling output current ripple via a resistor as claim 1, wherein said sawtooth signal generation unit includes:
a constant current source having an input end coupled with a DC voltage, and an output end providing a first current, wherein said first current is said constant current;
a capacitor having a first end coupled with said output end of said constant current source, and a second end coupled to a reference ground, wherein, said first end provides said sawtooth signal;
a switch having a first channel end coupled with said first end of said capacitor, a second channel end coupled to said reference ground, and a control input end coupled with a switching signal, wherein said switching signal becomes active to connect electrically said first channel end with said second channel end whenever said sawtooth signal rises in voltage to reach said comparison signal;
a current mirror including a first PMOS transistor and a second PMOS transistor, wherein said first PMOS transistor provides a second current to said capacitor;
an NMOS transistor having a drain, a gate, and a source, wherein, said drain is coupled with said second PMOS transistor, and said source is coupled with said external resistor; and
an amplifier having a positive input end coupled with an input voltage, a negative input end coupled with said source of said NMOS transistor, and an output end coupled with said gate of said NMOS transistor, wherein, said input voltage is provided by said positive voltage signal.

5. The PWM controller capable of controlling output current ripple via a resistor as claim 1, wherein said sawtooth signal generation unit includes:
a constant current source having an input end coupled with a DC voltage, and an output end providing a first current, wherein said first current is said constant current;
a capacitor having a first end coupled with said external resistor and said output end of said constant current source, and a second end coupled to a reference ground, wherein, said first end provides said sawtooth signal;
a switch having a first channel end coupled with said first end of said capacitor, a second channel end coupled to said reference ground, and a control input end coupled with a switching signal, wherein said switching signal becomes active to connect electrically said first channel end with said second channel end whenever said sawtooth signal rises in voltage to reach said comparison signal;
a current mirror including a first PMOS transistor and a second PMOS transistor, wherein said first PMOS transistor provides a second current to said capacitor;
an NMOS transistor having a drain, a gate, and a source, wherein, said drain is coupled with said second PMOS transistor;
an amplifier having a positive input end coupled with an input voltage, a negative input end coupled with said source of said NMOS transistor, and an output end coupled with said gate of said NMOS transistor, wherein, said input voltage is provided by said positive voltage signal; and
a resistor having one end coupled with said source of said NMOS transistor, and another end coupled to said reference ground.

6. An LED driver circuit capable of controlling output current ripple via a resistor, comprising:
a bridge rectifier having two AC input ends, a positive output end, and a negative output end, wherein said two AC input ends are coupled with an AC power, and said positive output end and said negative output end are used to provide a full-wave-rectified voltage;
a PWM controller having: a first lead coupled with a DC voltage; a second lead providing a PWM signal; a third lead coupled with a current sense signal; a fourth lead coupled to a reference ground; a fifth lead coupled with an external resistor to generate a control current; and a sixth lead coupled with an external capacitor to generate a comparison signal;
an NMOS transistor having a drain, a gate, and a source, wherein said drain is coupled with said positive output end, said gate is coupled with said second lead, and said source is coupled with said third lead;
a current sense resistor having one end coupled to said reference ground, and another end coupled with said third lead to provide said current sense signal according to a current flowing through said current sense resistor;
an inductor having one end coupled with said current sense resistor;
an LED module having one end coupled with another end of said inductor, and another end coupled with said negative output end; and
a diode having a cathode coupled with said third lead, and an anode coupled with said negative output end;
wherein, said PWM controller uses said external capacitor to filter an error signal to generate said comparison signal, said error signal being a difference of said current sense signal and a reference voltage; and performs a voltage comparison operation on said comparison signal and a sawtooth signal to determine a duty ratio of said PWM signal, wherein said sawtooth signal has a positive ramp, of which a slope is controlled by said control current.

7. The LED driver circuit capable of controlling output current ripple via a resistor as claim 6, wherein said slope of said positive ramp of said sawtooth signal is proportional or inversely proportional to said control current.

8. An LED driver circuit capable of controlling output current ripple via a resistor, comprising:
a bridge rectifier having two AC input ends, a positive output end, and a negative output end, wherein said two AC input ends are coupled with an AC power, and said positive output end and said negative output end are used to provide a full-wave-rectified voltage;
a PWM controller having: a first lead coupled with a DC voltage; a second lead providing a PWM signal; a third lead coupled with a current sense signal; a fourth lead coupled to a reference ground; a fifth lead coupled with an external resistor to generate a control current; and a sixth lead coupled with an external capacitor to generate a comparison signal;
an NMOS transistor having a drain, a gate, and a source, wherein said drain is coupled with said positive output end, said gate is coupled with said second lead, and said source is coupled to said reference ground;
a current sense resistor having one end coupled to said reference ground, and another end coupled with said third lead to provide said current sense signal according to a current flowing through said current sense resistor;
an inductor having one end coupled with said current sense resistor;
an LED module having one end coupled with another end of said inductor, and another end coupled with said negative output end; and
a diode having a cathode coupled with said reference ground, and an anode coupled with said negative output end;
wherein, said PWM controller is used to: reverse a polarity of said current sense signal to generate a positive voltage signal; use said external capacitor to filter an error signal to generate said comparison signal, said error signal being a difference of said positive voltage signal and a reference voltage; and perform a voltage comparison operation on said comparison signal and a sawtooth signal to determine a duty ratio of said PWM signal, wherein said sawtooth signal has a positive ramp, of which a slope is controlled by said control current.

9. The LED driver circuit capable of controlling output current ripple via a resistor as claim 8, wherein said slope of said positive ramp of said sawtooth signal is proportional or inversely proportional to said control current.
